(19) United States
(12) Patent Application Publication
(10) Pub. No.: US 2010/0036750 A1
(43) Pub. Date: Feb. 11, 2010

(54) System and method for displaying real estate properties for sale, real estate properties wanted and/or areas in which properties are for sale and/or desired

(76) Inventor: John Whelan, Chicago, IL (US)

Correspondence Address: PATENTS+TMS, P.C., 2849 W. ARMITAGE AVE., CHICAGO, IL, 60647, US

(21) Appl. No.: 12/221,952

(22) Filed: Aug. 8, 2008

(51) Int. Cl. G06Q 30/00; G06F 17/30

(52) U.S. Cl. 705/27

(57) ABSTRACT

A system and a method display real estate properties for sale, real estate properties wanted and/or areas in which properties are for sale and/or desired. The system and the method are used without defining whether the user is a buyer and/or a seller. Parameters selected by the user are compared with properties for sale and properties wanted stored in a database to generate a list of properties for sale and properties wanted that match the parameters. The parameters selected by the user may have a user-defined geographical location that may be established by the user choosing points of longitude and latitude. The system and method may indicate a real-time supply and/or demand of specific property types. The system and method may be global in scope and may function in any currency.

### BACKGROUND OF THE INVENTION

The present invention generally relates to a system and a method for displaying real estate properties for sale, real estate properties wanted and/or areas in which properties are for sale and/or desired. More specifically, the present invention relates to a system and a method for displaying real estate properties for sale, real estate properties wanted and/or areas in which properties are for sale and/or desired that compare parameters selected by the user with the real estate properties for sale, the real estate properties wanted and/or the areas in which properties are for sale and/or desired to determine the properties for sale, the real estate properties wanted and/or the areas in which properties are for sale and/or desired that have characteristics that match the parameters selected by the user. The system and method may be used without defining whether the user is a buyer and/or a seller. The parameters selected by the user may have a user-defined geographical location that may be established by various user-selected points of longitude and latitude. The system may indicate a real-time supply and demand of specific property types. The system may enable a first user to contact a second user regarding purchase or sale of a property by the second user.

The real estate market is one of the oldest markets in the world. Properties have been bought and sold for hundreds of years. In that time, although technology has changed, the real estate market has functioned essentially without change. Namely, a seller finds a forum to list a property for sale and then waits to be contacted by a potential buyer.

Known tools available to a participant in the real estate market are focused on the “sell” side of the market. Specifically, newspapers, real estate brokers, multiple listing services, for sale by owner services and online listing services merely provide the forum for the seller to list the property for sale and then wait to be contacted by the potential buyer. Thus, only properties for sale are provided by these known tools.

Thus, the known tools do not indicate both properties for sale and properties wanted to enable sellers to identify possible buyers and/or to contact the possible buyers. Ideally, the participant in the real estate market would have all of the properties for sale, their locations and their prices displayed simultaneously with all of the properties wanted, the areas in which the properties wanted are located and their price ranges. However, the known tools do not allow buyers to advertise a property they want, a desired price range and/or a geographically specific area that is desired, and have proactive sellers contact the buyer even prior to the seller formally listing the properties for sale.

A known method for selecting a property by a buyer generally involves contacting a real estate agent. Alternatively, for sale by owner services and online real estate listings allow buyers to use the internet to identify available properties that meet the desires, requirements and/or priorities of the buyer without using the real estate agent. Further, sellers may list their property online via the internet without using the real estate agent. Thus, buyers and/or sellers use the online real estate listings to avoid expenditure of time and/or money associated with using the real estate agent.

The online real estate listings enable the buyer to search for properties for sale. Such searches may be executed from and/or may provide access to databases connected to a computer network via the internet. The online real estate listings require input from the buyer, such as, for example, a desired location, a price range and/or a type of property.

Buyers of real estate often experience difficulty using the online real estate listings to locate a property that meets specific parameters. To find a property from among many available properties causes the buyer to expend money and/or time. The money and/or time spent determining which of the available properties have characteristics desired by the purchaser may be detrimental to the progress and/or the goal of purchasing a property.

For example, known online real estate listings do not allow the buyer to define a specific geographic area of interest. Known online real estate listings often require the buyer to identify a city name and/or a zip code and do not allow the user to establish the geographic boundaries within which a property is sought. For example, the buyer may be interested in only a portion of a zip code, and known online real estate listings do not allow the buyer to specify a precise geographic region in which the buyer is interested. Further, known real estate listing services do not provide a forum for the buyer to list a property wanted and the area in which it is desired, allowing the buyer to wait for a suitable seller to approach the buyer with information regarding a property that the seller may be interested in selling. Moreover, known online real estate listings do not provide an interactive map that displays the properties for sale and the properties wanted. Additionally, known online real estate listings do not give sellers direct access to a pool of buyers nor do known online real estate listing services allow sellers to proactively contact buyers.

Real-time supply-and-demand information is critical to the setting of an asking price by a seller and/or a bid by a buyer. However, known online real estate listings do not provide real-time supply-and-demand information. In addition, known online real estate listings also require the user to declare whether they are a buyer or a seller and thereby limit the information and options available to the user.

Thus, the known tools for the real estate market create a passive market by requiring the seller to wait for the potential buyer to contact them. In addition, a seller may exaggerate a size and/or a condition of their property for sale. The known real estate tools do not have a feedback loop for buyers who have visited the property to provide objective feedback. Such a feedback loop would encourage sellers to be more accurate with the information about their properties for sale. The known real estate tools also lack a global platform for buyers and sellers to list the properties for sale and the properties wanted in any country and in any currency.

A need, therefore, exists for a system and a method for displaying real estate properties for sale, real estate properties wanted and/or areas in which properties are for sale and/or desired. Further, a need exists for an online peer-to-peer real estate marketplace that displays properties available for purchase from a seller and/or properties wanted by a buyer. Still further, a need exists for a system and a method for displaying real estate properties for sale, real estate properties wanted and/or areas in which properties are for sale and/or desired that may be used without defining whether the user is a buyer and/or a seller. Still further, a need exits for a system and a method for displaying real estate properties for sale, real estate properties wanted and/or areas in which properties are for sale and/or desired that employ a user-defined geographical location established by various user-selected points of longitude and/or latitude. Still further, a need exits for a system and a method for displaying real estate properties for sale, real estate properties wanted and/or areas in which properties are for sale and/or desired that indicate a real-time supply and/or demand of specific property types. Moreover, a need exists for a system and a method for displaying real estate properties for sale, real estate properties wanted and/or areas in which properties are for sale and/or desired that enable a first user to contact a second user regarding purchase or sale of a property by the second user.

### SUMMARY OF THE INVENTION

The present invention generally relates to a system and a method for displaying real estate properties for sale, real estate properties wanted and/or areas in which properties are for sale and/or desired. More specifically, the present invention relates to a system and a method for displaying real estate properties for sale, real estate properties wanted and/or areas in which properties are for sale and/or desired that compare parameters selected by the user with the properties for sale, the real estate properties wanted and/or the areas in which properties are for sale and/or desired to determine which properties for sale, which real estate properties wanted and/or which areas in which properties are for sale and/or desired have characteristics that match the parameters selected by the user. The system and method may be used without defining whether the user is a buyer and/or a seller.

The parameters selected by the user may have a user-defined geographical location that may be established by various user-selected points of longitude and/or latitude. The system and the method may indicate a real-time supply and/or demand of specific property types. The system and the method may enable a first user to contact a second user regarding purchase or sale of a property by the second user. The system and the method may provide an interactive map of properties worldwide with prices of the properties for sale and/or the properties wanted displayed in any currency.

One or more users may use a network to register with the system. The system may have a database and a web application. One or more of the users may provide a property for sale by input of property characteristics into the system. The property characteristics of the property for sale may be, for example, a specific location, a price, a property type, a number of bedrooms, a number of bathrooms and/or the like. The specific location of the property for sale may be, for example, an address, an intersection, a latitude and/or a longitude and/or the like. The property type of the property for sale may be, for example, vacant land, a single family home, a townhome, a condominium, a mobile home, a two-unit, a three-unit, a four-unit and/or the like.

One or more users may provide a property wanted by input of property characteristics into the system. The property characteristics of the property wanted may be, for example, a specific location, a price range, a property type, a minimum number of bedrooms, a minimum number of bathrooms and/or the like. The specific location of the property wanted may be, for example, an address, an intersection, an area bounded by user-selected points of a latitude and a longitude and/or the like. The property type of the property wanted may be, for example, vacant land, a single family home, a townhome, a condominium, a mobile home, a two-unit, a three-unit, a four-unit and/or the like.

One or more of the users may use the system to locate properties for sale and/or properties wanted that have property characteristics that match user-selected parameters. The user-selected parameters may be, for example, a general location, a price range, a property type, a number of bedrooms, a number of bathrooms and/or the like. The general location may be, for example, a city in the United States, a zip code in the United States and/or a city outside of the United States. The system may provide an interactive map of the location that may display properties for sale and/or properties wanted that have property characteristics that may match the user-selected parameters. The property for sale and/or the property wanted may be represented by an icon on the interactive map. One or more of the users may use the interactive map to obtain details about a property for sale and/or a property wanted by selecting a property icon on the. interactive map.

As a result, properties wanted by users and properties for sale by users may be displayed simultaneously on the interactive map. A first user may use the system to contact a second user regarding purchase or sale of a property by the second user. Moreover, the system may verify information of and/or may rank properties for sale and/or properties wanted.

To this end, in an embodiment of the present invention, a method for displaying real estate properties for sale and real estate properties wanted is provided. The method has the steps of providing a web application via a network wherein the network is connected to a database that stores information regarding the real estate properties for sale and information regarding the real estate properties wanted and further wherein the web application communicates with the database via the network; displaying a map on the web application; displaying a first set of icons on the map wherein the first set of icons is associated with the real estate properties for sale; displaying a second set of icons on the interactive map wherein the second set of icons is associated with the real estate properties wanted; inputting a parameter; comparing the parameter to the information for the real estate properties for sale and the information for the real estate properties wanted; and indicating which icons of the first set of icons are associated with the real estate properties for sale that have information that matches the parameter and which icons of the second set of icons are associated with the real estate properties wanted that have information that matches the parameter.

In an embodiment, the first set of icons is different than the second set of icons.

In an embodiment, the method has the step of displaying a new icon on the interactive map wherein the new icon is associated with a new real estate property for sale.

In an embodiment, the method has the step of displaying a new icon on the map wherein the new icon is associated with a new real estate property wanted.

In an embodiment, the method has the step of removing one of the first set of icons after one of the real estate properties for sale is no longer listed.

In an embodiment, the method has the step of converting prices for the real estate properties for sale and the real estate properties wanted from a first type of currency to a second type of currency wherein the first type of currency is different than the second type of currency.

In an embodiment, the method has the step of removing one of the second set of icons after one of the real estate properties wanted is no longer listed.

In an embodiment, the method has the step of displaying the information if a user selects one of the icons.

In an embodiment, the method has the step of displaying the web application on a plurality of computers wherein the plurality of computers are connected to the network and further wherein the network is the internet.

In an embodiment, the method has the step of adjusting a location of one of the first set of icons wherein adjustment of the location is based on user input.

In an embodiment, the method has the step of compiling feedback information for the real estate properties for sale wherein the web application compiles the feedback information and further wherein the feedback information is input from users that have contacted owners of the real estate properties for sale.

In an embodiment, the method has the step of changing the information regarding the real estate properties for sale and the information regarding the real estate properties wanted wherein the database stores changes in the information regarding the real estate properties for sale and the information regarding the real estate properties wanted.

In an embodiment, the method has the step of adjusting the map to show any location in the world.

In another embodiment of the present invention, a system for displaying real estate data is provided. The system has a database connected to a network wherein the database stores information associated with real estate properties for sale and real estate properties wanted; a web application associated with the database wherein a user views the web application on a computer connected to the network and further wherein the web application accepts user input; a map displayed on the web application wherein the map displays icons that represent the real estate properties for sale and the real estate properties wanted that match the user input; and a graphic representation displayed on the web application wherein the graphic representation indicates how many of the real estate properties for sale have information that matches the user input and how many of the real estate properties wanted have information that matches the user input.

In an embodiment, the system has a server that stores the database wherein the server is located at a location remote from the computer connected to the network.

In another embodiment of the present invention, a method for displaying real estate information is provided. The method has the steps of providing a web application via a computer network; displaying a map on the web application; inputting three or more geographic points that define a perimeter of an area in which a property wanted is located wherein the three or more geographic points are input via the web application by a first user; and displaying a first icon on the map wherein the first icon on the map is associated with the property wanted and the area in which the property wanted is located.

In an embodiment, the method has the step of displaying information regarding the area in which the property wanted is located wherein the information is displayed to a second user if the second user selects the first icon.

In an embodiment, the method has the step of displaying a second icon on the map wherein the second icon is associated with a real estate property for sale and further wherein the first icon is different than the second icon.

In an embodiment, the method has the step of adjusting the map to show any location in the world.

In an embodiment, the method has the step of displaying a ranking for the property wanted wherein the ranking is based on information associated with the property wanted.

It is, therefore, an advantage of the present invention to provide a system and a method for displaying real estate properties for sale, real estate properties wanted and areas in which properties are for sale and/or desired.

Another advantage of the present invention is to provide a system and a method for displaying real estate properties for sale, real estate properties wanted and areas in which properties are for sale and/or desired that display an interactive map.

Yet another advantage of the present invention is to provide a system and a method for displaying real estate properties for sale, real estate properties wanted and areas in which properties are for sale and/or desired that display properties available for purchase from a seller and properties wanted by a buyer simultaneously.

And, another advantage of the present invention is to provide a system and a method for displaying real estate properties for sale, real estate properties wanted and areas in which properties are for sale and/or desired that are used without defining whether the user is a buyer and/or a seller.

Further, an advantage of the present invention is to provide a system and a method for displaying real estate properties for sale, real estate properties wanted and areas in which properties are for sale and/or desired that compare parameters selected by the user with a plurality of properties for sale and/or properties wanted stored in a database to determine which properties for sale and/or properties wanted have characteristics that match the parameters selected by the user.

Yet another advantage of the present invention is to provide a system and a method for displaying real estate properties for sale, real estate properties wanted and areas in which properties are for sale and/or desired that employ a user-defined geographical area in which the user is interested in purchasing a property.

A still further advantage of the present invention is to provide a system and a method for displaying real estate properties for sale, real estate properties wanted and areas in which properties are for sale and/or desired that indicate a real-time supply and demand of specific property types.

Further, an advantage of the present invention is to provide a system and a method for displaying real estate properties for sale, real estate properties wanted and areas in which properties are for sale and/or desired that enable a first user to contact a second user regarding purchase or sale of property by the second user.

Moreover, an advantage of the present invention is to provide a system and a method for displaying real estate properties for sale, real estate properties wanted and areas in which properties are for sale and/or desired that provide an interactive map of properties worldwide with prices of the properties displayed in any currency.

Additional features and advantages of the present invention are described in, and will be apparent from, the detailed description of the presently preferred embodiments and from the drawings.

### BRIEF DESCRIPTION OF THE DRAWINGS

FIG. 1 illustrates a diagram of interconnected computers and a database in an embodiment of the present invention.

FIG. 2 illustrates a black box diagram of users utilizing an embodiment of the present invention.

FIG. 3 illustrates a screen shot of a web application in an embodiment of the present invention.

FIG. 4 illustrates a screen shot of a web application in an embodiment of the present invention.

FIG. 5 illustrates a flowchart of a method of an embodiment of the present invention.

### DETAILED DESCRIPTION OF THE PRESENTLY PREFERRED EMBODIMENTS

The present invention generally relates to a system and a method for displaying real estate properties for sale, real estate properties wanted and/or areas in which properties are for sale and/or desired. More specifically, the present invention relates to a system and a method for displaying real estate properties for sale, real estate properties wanted and areas in which properties are for sale and/or desired that compare parameters selected by the user with the properties for sale and/or properties wanted to determine which properties for sale and/or which properties wanted have characteristics that match the parameters selected by the user. The system and/or the method may be used without defining whether the user is a buyer and/or a seller.

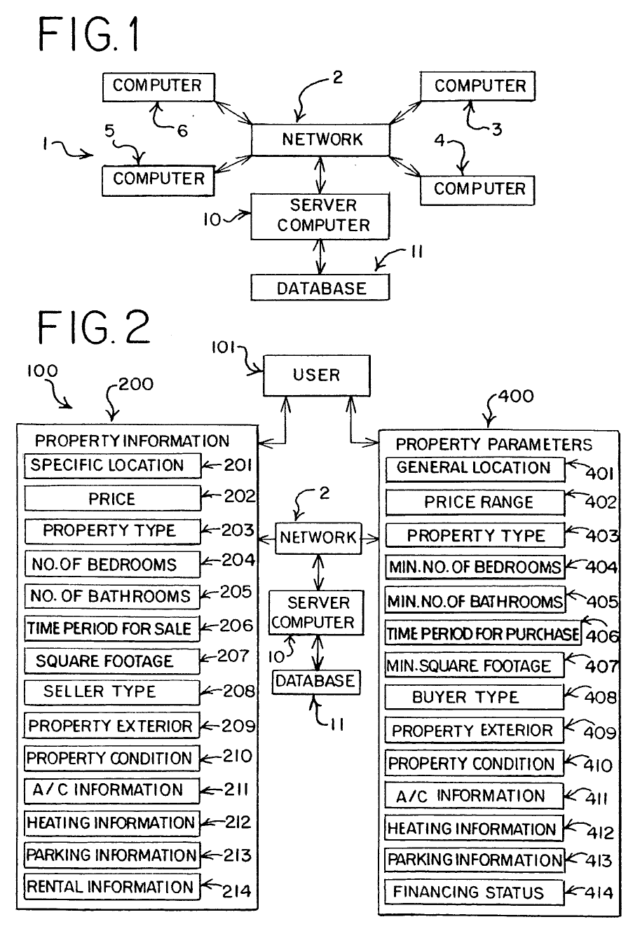

Referring now to the drawings wherein like numerals refer to like parts, FIG. 1 generally illustrates a system 1 for displaying real estate properties for sale, real estate properties wanted and areas in which properties are for sale and/or desired. The system 1 may have a computer network 2 having computers 3, 4, 5, 6 (hereinafter “computers 3-6”) connected thereto and in communication therewith. Further, the computer network 2 may have one or more server computers 10 that may be associated with a database 11. The server computer 10 may be remote relative to the computers 3-6.

The computer network 2 may be any type of computer network that may connect one or more of the computers 3-6. Any number of computers may be connected to the computer network 2, and the invention should not be construed as limited to a specific number of computers. Further, the computer network 2 may be, for example, the internet wherein remote computers are connected and/or in communication via a telephone network, broadband network, a wireless network or other like network. In addition, the computer network 2 may be an intranet wherein the computers 3-6 are connected via a network internal to an organization, such as, for example, a business, an institution or the like. For example, the computer network 2 may be connected via a LAN network. However, the computer network 2 may be any computer network known to one skilled in the art.

In a preferred embodiment, the database 11 may be web-accessible. Further, the database 11 may be accessible via a web application 20 associated with the database 11. The web application 20 may provide an electronic form for a user to enter information into the database 11 and/or for the user to obtain the information from the database 11. Further, the user may have a username and/or a password to maintain privacy and/or to change and/or save personal information input into the database 11 or taken from the database 11. Registration information, such as, for example, a name, an address, a credit card number, a bank account number and/or the like, may be required to obtain the username and/or the password. The database 11 may be accessed via a single web application or via multiple web applications that may be linked to the database 11.

The server computer 10 may be associated with and/or in communication with the database 11. The database 11 may contain information associated with one or more properties. Users may utilize any of the computers 3-6 or any other computer connected via the computer network 2 to access the database 11 through the computer network 2. One or more of the users may input information regarding a property into the database 11. One or more of the users of the database 11 may use any of the computers 3-6 or any other computer to access and/or to obtain the information from the database 11. The computer network 2 may provide real time updates and/or access to the real time updates regarding information concerning a property for sale and/or a property wanted. In a preferred embodiment, the users may input and/or may access the information regarding the property for sale and/or the property wanted via the web application 20.

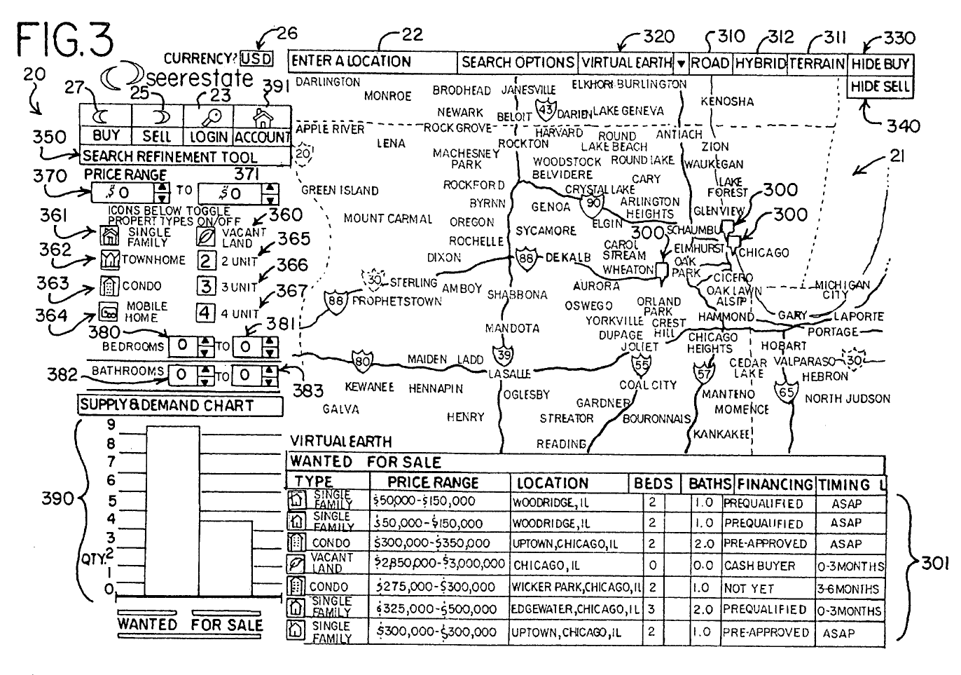

FIG. 2 generally illustrates a black box diagram of a system 100 for displaying real estate properties for sale, real estate properties wanted and areas in which properties are for sale and/or desired. FIG. 3 generally illustrates a screen shot of the web application 20 of the system 100 for displaying real estate properties for sale, real estate properties wanted and areas in which properties are for sale and/or desired. The network 2, the server computer 10 and/or the database 11 may be designed and/or may be programmed to provide the system 100 and/or the web application 20. A user 101 may access and/or may retrieve the web application 20 from the server computer 10 via the network 2. For example, the user 101 may access and/or may retrieve the web application 20 using a web browser located on any computer connected to the network 2.

The server computer 10, the database 11, the system 100 and/or the web application 20 may be designed and/or programmed to display an interactive map 21 on the web application 20. The web application 20 may display an entirety of web application content in one page so that scrolling by the user 101 is unnecessary. In a preferred embodiment, the server computer 10, the database 11, the system 100 and/or the web application 20 may be designed and/or may be programmed for the web application 20 to require an amount of screen space equal to or less than an amount of available screen space of the web browser. The server computer 10, the database 11, the system 100 and/or the web application 20 may be designed and/or may be programmed to provide an input box 22 on the web application 20 that may allow the user to input a location, such as, for example, a continent, a country, a city, an address and/or the like for the interactive map 21 to display the location. In a preferred embodiment, the location may be any location in the world. In a preferred embodiment, the server computer 10, the database 11, the system 100 and/or the web application 20 may be designed and/or may be programmed to be capable of displaying any location in the world on the interactive map 21. The server computer 10, the database 11, the system 100 and/or the web application 20 may be designed and/or may be programmed to allow the user 101 to establish a default location so that a subsequent use of the system 100 begins with the interactive map 21 displaying the default location. The user 101 may use a mouse, other pointing device and/or the like (not shown) connected to one of the computers 3-6 to control the interactive map 21.

The interactive map 21 may provide a view of a geographic area surrounding the location. The server computer 10, the database 11, the system 100 and/or the web application 20 may be designed and/or may be programmed to enable the user 101 to adjust the interactive map 21. For example, the network 2, the server computer 10 and/or the database 11 may be designed and/or may be programmed to enable the user 101 to adjust a magnification of the interactive map 21. The user 101 may increase and/or may decrease the magnification of the interactive map 21. Increasing the magnification may cause the interactive map 21 to display more detail of the location and/or display a decreased amount of the geographic area surrounding the location. Decreasing the magnification may cause the interactive map 21 to display less detail of the location and/or display an increased amount of the geographic area surrounding the location.

For example, increasing the magnification of the interactive map 21 may cause the interactive map 21 to display street-level detail of the location and/or to display a smaller portion of the geographic area surrounding the location. As a further example, increasing the magnification of the interactive map 21 may cause the interactive map 21 to display highway-level detail of the location and/or to display a larger portion of the geographic area surrounding the location, such as, for example, adjacent cities.

The server computer 10, the database 11, the system 100 and/or the web application 20 may be designed and/or may be programmed to enable the user 101 to adjust a location displayed at a center of the interactive map 21. For example, a first location may be displayed at the center of the interactive map 21. The user 101 may adjust the interactive map 21 so that the first location may be moved from the center of the interactive map 21 to a new position on the interactive map 21. After moving the first location from the center of the interactive map 21 to the new position on the interactive map 21, a second location may be displayed at the center of the interactive map 21.

The server computer 10, the database 11, the system 100 and/or the web application 20 may be designed and/or may be programmed to enable the user 101 to use the mouse, the other pointing device and/or the like to drag the interactive map 21. Dragging the interactive map 21 may move the first location from the center of the interactive map 21 to the new position on the interactive map 21. Dragging the interactive map 21 may establish the second location as the center of the interactive map 21. The server computer 10, the database 11, the system 100 and/or the web application 20 may be designed and/or may be programmed to enable the interactive map 21 to be adjusted in any direction desired by the user 101.

Adjustment of the interactive map 21 may allow the user 101 to view adjacent geographic areas not previously displayed on the interactive map 21. Adjustment of the interactive map 21 may cause the interactive map 21 to display portions of the interactive map 21 that depict the adjacent geographic areas not previously displayed. In a preferred embodiment, the portions of the interactive map 21 that depict the adjacent geographic areas not previously displayed may be downloaded from the server computer 10 and/or inserted into the interactive map 21. The server computer 10, the database 11, the system 100 and/or the web application 20 may be designed and/or may be programmed to download the portions of the interactive map 21 that depict the adjacent geographic areas not previously displayed from the server computer 10. The server computer 10, the database 11, the system 100 and/or the web application 20 may be designed and/or may be programmed to insert the portions of the interactive map 21 that depict the adjacent geographic areas not previously displayed into the interactive map 21.

If the portions of the interactive map 21 that depict the adjacent geographic areas not previously displayed are downloaded from the server computer 10 and/or inserted into the interactive map 21, the web application 20 may not be required to reload. Thus, portions of the interactive map 21 originally displayed by the interactive map 21 may remain displayed during download of the portions of the interactive map 21 that depict the adjacent geographic areas not previously displayed. The server computer 10, the database 11, the system 100 and/or the web application 20 may be designed and/or may be programmed to re-position the portions of the interactive map 21 originally displayed by the interactive map 21 to new locations on the interactive map 21. If the portions of the interactive map 21 originally displayed by the interactive map 21 remain displayed during download of the portions of the interactive map 21 that depict the adjacent geographic areas not previously displayed, the system 100 may not be required to generate an entirely new interactive map 21 on the web application 20. The server computer 10, the database 11, the system 100 and/or the web application 20 may be designed and/or may be programmed to adjust the interactive map 21 without generating the entirely new interactive map 21.

The server computer 10, the database 11, the system 100 and/or the web application 20 may be designed and/or may be programmed to have and/or to access preexisting map tiles for use in the interactive map 21. In a preferred embodiment, the preexisting map tiles may depict and/or correspond to every location in the world. The preexisting map tiles may be accessed via the network 2. The server computer 10, the database 11, the system 100 and/or the web application 20 may be designed and/or may be programmed to use the preexisting map tiles as the portions of the interactive map 21 originally displayed by the interactive map 21 and/or the portions of the interactive map 21 that depict the adjacent geographic areas not previously displayed. When the location is input by the user 100, the system 100 may determine which one of the preexisting map tiles may depict and/or may correspond to the location. The interactive map 21 may display the map tile that represents the location.

When the location is input by the user 100, the system 100 may determine which one or more of the preexisting map tiles represent geographic areas adjacent to the location. The server computer 10, the database 11, the system 100 and/or the web application 20 may be designed and/or may be programmed to transmit the map tiles that represent the geographic areas adjacent to the location to a computer on which the interactive map 21 is displayed. Therefore, when the user 100 adjusts the interactive map 21, the web application 100 may insert the map tiles that represent the adjacent geographic areas as new portions of the interactive map 21.

The server computer 10, the database 11, the system 100 and/or the web application 20 may be designed and/or may be programmed to enable the user 101 to list a property for sale on the system 100 and/or the web application 20. The property for sale may be listed on the system 100 and/or the web application 20 by selecting a “sell” button 25 on the web application 20. The server computer 10, the database 11, the system 100 and/or the web application 20 may be designed and/or may be programmed to require the user 101 that may list the property to input the username and/or the password to list the property on the web application 20. The server computer 10, the database 11, the system 100 and/or the web application 20 may be designed and/or may be programmed to enable the user 101 that may list the property for sale to input property information 200 for the property for sale into the web application 20. The server computer 10, the database 11, the system 100 and/or the web application 20 may be designed and/or may be programmed to transmit the property information 200 to and/or store the property information on the database 11.

The server computer 10, the database 11, the system 100 and/or the web application 20 may be designed and/or may be programmed to provide an electronic form on the web application 20 for listing the property for sale. The user 101 that may list the property may input the property information 200 using the electronic form for listing a property. The electronic form for listing a property may be a section of the web application 20 that may have input boxes in which the property information 200 may be typed by the user 101.

The property information 200 for the property for sale may be, for example, a specific location 201, a price 202, a property type 203, a number of bedrooms 204, a number of bathrooms 205, a desired time period for sale 206, approximate square footage 207, seller type 208, property exterior 209, property condition 210, air conditioning information 211, heating information 212, parking information 213, rental information 214 and/or the like.

The specific location 201 may be, for example, an address, an intersection, a latitude and/or a longitude, and/or the like. The server computer 10, the database 11, the system 100 and/or the web application 20 may be designed and/or may be programmed to accept input of the price 202 in any currency. For example, the server computer 10, the database 11, the system 100 and/or the web application 20 may be designed and/or may be programmed to may provide a currency menu (not shown) to enable the user 101 to select which currency is being used for the price 202.

The property type 203 may be, for example, vacant land, a single family home, a townhome, a condominium, a mobile home, a two-unit, a three-unit, a four-unit and/or the like. The desired time period for sale 206 may be, for example, “as soon as possible”, a time period expressed in months, pre-foreclosure, foreclosure and/or the like. The seller type 208 may be, for example, an agent or an owner. The property exterior 209 may be, for example, brick, siding, wood and/or the like. The property condition 210 may be, for example, excellent, good, needs work, renovation and/or the like. The air conditioning information 211 may be, for example, central air conditioning, window units and/or the like. The heating information 212 may be, for example, gas, radiator, space heater and/or the like. The parking information 213 may be, for example, garage, street, a number of spaces and/or the like. The rental information 214 may be, for example, whether the property is rented, a rental price per month, a security deposit amount, a lease expiration date, utilities information and/or the like. The utilities information may be, for example, whether none of the utilities are included in rent, whether some of the utilities are included in rent, or whether all of the utilities are included in rent. The present invention should not be restricted to a specific embodiment of the property information 200 for the property for sale.

The server computer 10, the database 11, the system 100 and/or the web application 20 may be designed and/or may be programmed to transmit the property information 200 to the server computer 10 via the network and/or to store the property information 200 in the database 11 under an entry for the property for sale. The database 11 may associate the property information 200 with the property for sale. The user 101 that may list the property for sale may later add to, delete and/or edit the property information 200 in the database 11. For example, the user 101 that may list the property for sale may later change the price 201. The server computer 10, the database 11, the system 100 and/or the web application 20 may be designed and/or may be programmed to require the user 101 that may list the property for sale to input the username and/or the password to add to, delete and/or edit the property information 200. For example, the web application 20 may provide a “login” button 23 that may be selected by the user 101. If the user 101 selects the “login” button 23, the web application 20 may display input areas for the username and/or the password.

After receiving the property information 200 for the property for sale, the system 100 may display an icon 300 representing the property for sale on the interactive map 21. The server computer 10, the database 11, the system 100 and/or the web application 20 may be designed and/or may be programmed to display the icon 300 representing the property for sale on the interactive map 21. The server computer 10, the database 11, the system 100 and/or the web application 20 may be designed and/or may be programmed to enable the user 101 that may list the property to adjust a location of the icon 300 on the interactive map 21. For example, the user 101 that may list the property for sale may adjust the location of the icon 300 on the interactive map 21 if the icon 300 does not accurately indicate the specific location of the property for sale. Therefore, the system 100 may allow the user 101 that may list the property to correct inaccuracies that may be caused by imperfect mapping technology. For example, if the system 100 uses an address provided by the user 101 to incorrectly display the icon 300, The server computer 10, the database 11, the system 100 and/or the web application 20 may be designed and/or may be programmed to allow the user 101 to re-position the icon 300 to a correct location on the interactive map 21. The server computer 10, the database 11, the system 100 and/or the web application 20 may be designed and/or may be programmed to assign a latitude and/or a longitude for the correct location of the property for sale.

The web application 20 may have a detail area 301 that may display the property information 200 for properties displayed on the interactive map 21. The server computer 10, the database 11, the system 100 and/or the web application 20 may be designed and/or may be programmed to display the detail area 301 on the web application 20. For example, the detail area 301 may provide the property type 203, the price 202, the address, the city, the number of bedrooms 204, the number of bathrooms 205, a date the property was listed, and/or the desired time period for sale 206.

In an embodiment, the user 101 may obtain the property information 200 via mobile telephone text message. For example, the property for sale may have a sign posted on the property for sale that may indicate a telephone number to which the user 101 may send an inquiry text message. The inquiry text message may prompt the system 100 to send a reply text message that may indicate the property information 200, such as, for example, the price 202 and/or the property type 203. The server computer 10, the database 11, the system 100 and/or the web application 20 may be designed and/or may be programmed to send the reply text message. The inquiry text message may indicate a phone number of the user 101. The server computer 10, the database 11, the system 100 and/or the web application 20 may be designed and/or may be programmed to provide an owner of the property for sale with the phone number of the user 101 that sent the inquiry text message. For example, the owner of the property for sale may be provided with the phone number of the user 101 by a contact information text message, an email and/or the like. The phone number of the user 101 that sent the inquiry text message may enable the owner of the property for sale to contact the user 101 that sent the inquiry text message.

For example, the property for sale may have a sign posted on the property for sale that may state “Text 1-800-123-4567 for more details”. The user 101 may send the inquiry text message to a telephone number, such as, for example, the number 1-800-123-4567. The system 100 may send the reply text message that may indicate the property information, such as, for example, the price 202 and/or the property type 203. The inquiry text message may indicate the phone number of the user 101. The system 100 may provide the owner of the property for sale with the phone number of the user 101 that sent the inquiry text message, such as, for example, by a contact information text message, an email and/or the like. The owner of the property for sale may contact the user 101 that sent the inquiry text message using the phone number of the user 101 that sent the inquiry text message.

The server computer 10, the database 11, the system 100 and/or the web application 20 may be designed and/or may be programmed to enable the user 101 to define a property wanted. The property wanted may be defined by selecting a “buy” button 27 on the web application 20. The server computer 10, the database 11, the system 100 and/or the web application 20 may be designed and/or may be programmed to require the user 101 that may be interested in buying a property to input the username and/or the password to define the property wanted. The user 101 that may be interested in buying a property may use the web application 20 to provide property parameters 400 for the property wanted to the database 11.

The user 101 that may be interested in buying a property may input the property parameters 400 using an electronic form for buying provided by the web application 20. The electronic form for buying may be a section of the web application 20 that may have input boxes in which the property parameters 400 may be typed by the user 101.

The property parameters 400 for the property wanted may be, for example, a general location 401, a price range 402, a property type 403, a minimum number of bedrooms 404, a minimum number of bathrooms 405, a desired time period for purchase 406, a minimum square footage 407, buyer type 408, property exterior 409, property condition 410, air conditioning information 411, heating information 412, parking information 413, financing status 414 and/or the like.

The general location 401 may be, for example, a city, a neighborhood in the city, a zip code and/or the like. The server computer 10, the database 11, the system 100 and/or the web application 20 may be designed and/or may be programmed to accept input of the price range 402 in any currency. For example, the server computer 10, the database 11, the system 100 and/or the web application 20 may be designed and/or may be programmed to may provide a currency menu (not shown) to enable the user 101 to select which currency is being used for the price range 402.

The property type 403 may be, for example, vacant land, a single family home, a townhome; a condominium, a mobile home, a two-unit, a three-unit, a four-unit and/or the like. The desired time period for purchase 406 may be, for example, “as soon as possible”, zero to three months, three months to six months, one year and/or the like. The buyer type 408 may be, for example, agent or individual. The property exterior 409 may be, for example, brick, siding, wood and/or the like. The property condition 410 may be, for example, excellent, good, needs work, renovation and/or the like. The air conditioning information 411 may be, for example, central air conditioning, window units and/or the like. The heating information 412 may be, for example, gas, radiator, space heater and/or the like. The parking information 413 may be, for example, garage, street, a number of spaces and/or the like. The financing status 414 may be, for example, “not yet”, pre-qualified, pre-approved, cash buyer and/or the like. The present invention should not be restricted to a specific embodiment of the property parameters 400 for the property wanted.

The server computer 10, the database 11, the system 100 and/or the web application 20 may be designed and/or may be programmed to transmit the property parameters 400 to the server computer 10 via the network 2. The server computer 10, the database 11, the system 100 and/or the web application 20 may be designed and/or may be programmed to store the property parameters in the database 11 under an entry for the property wanted. The user 101 that may be interested in buying a property may later add to, delete and/or edit the property parameters 400 in the database 11. For example, the user 101 that may be interested in buying a property may later change the price range 402.

The server computer 10, the database 11, the system 100 and/or the web application 20 may be designed and/or may be programmed to require the user 101 that may be interested in buying a property to input the username and/or the password to add to, delete and/or edit the property parameters 400. For example, the web application 20 may provide the “login” button 23 that may be selected by the user 101. If the user 101 selects the “login” button 23, the web application 20 may display input areas for the username and/or the password.

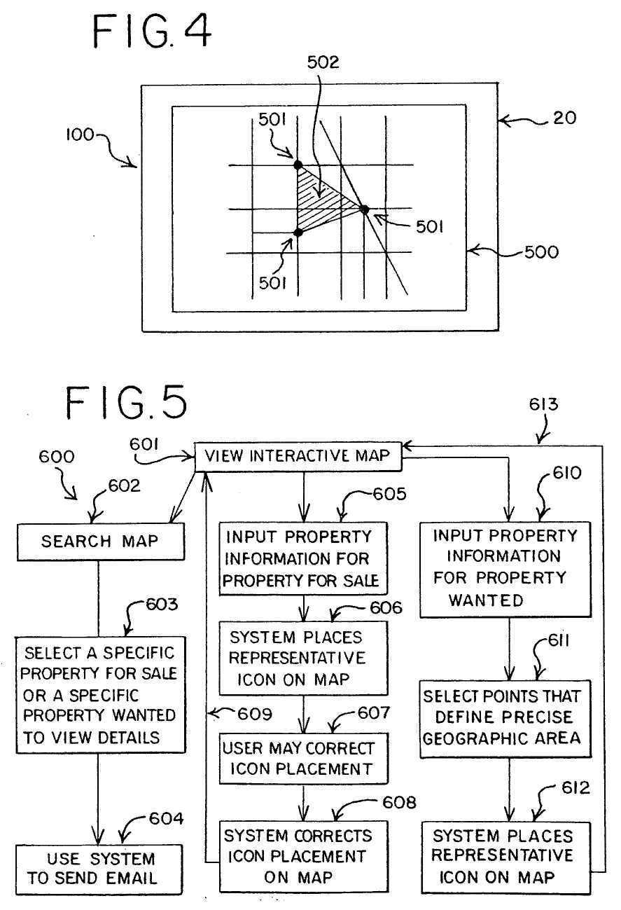

As generally illustrated in FIG. 4, after receiving the property parameters 400 for the property wanted, the server computer 10, the database 11, the system 100 and/or the web application 20 may be designed and/or may be programmed to display a drawing map 500 on the web application 20. The drawing map 500 may be superimposed over the interactive map 21 on the web application 20. Alternatively, the interactive map 21 may be used as the drawing map 500.

The server computer 10, the database 11, the system 100 and/or the web application 20 may be designed and/or may be programmed for the drawing map 500 to depict the general location of the property wanted. The server computer 10, the database 11, the system 100 and/or the web application 20 may be designed and/or may be programmed for the drawing map 500 to enable the user 101 to select three or more points 501 that define a precise geographic area 502 in which the property wanted is located.

For example, the server computer 10, the database 11, the system 100 and/or the web application 20 may be designed and/or may be programmed to enable the user 101 to use the mouse, the other pointing device and/or the like to select the three or more points 501 within the drawing map 500. The three or more points 501 selected by the user 101 may define a perimeter of the precise geographic area 502 in which the property wanted is located. The precise geographic area 502 in which the property wanted is located may be any shape and/or any size. In a preferred embodiment, the server computer 10, the database 11, the system 100 and/or the web application 20 may be designed and/or may be programmed to enable the user 101 to select an infinite number of the three or more points 501 on the drawing map 500. The server computer 10, the database 11, the system 100 and/or the web application 20 may be designed and/or may be programmed to assign a latitude and/or a longitude for each of the three or more points 501.

Referring again to FIG. 3, the server computer 10, the database 11, the system 100 and/or the web application 20 may be designed and/or may be programmed to display an icon 300 representing the property wanted on the interactive map 21. The icon 300 representing the property wanted may be located at an approximate center point of the precise geographic area 502. The icon 300 may vary based on the property type 403. For example, the icon 300 may be a different shape, a different size, a different design and/or a different color based on the property type 403 that the icon 300 represents.

For example, the icon 300 for the vacant land may be a first color, the icon 300 for the single family home may be a second color, the icon 300 for the townhome may be a third color, the icon 300 for the condominium may be a fourth color, the icon 300 for the mobile home may be a fifth color, the icon 300 for the two-unit may be a sixth color, the icon 300 for the three-unit may be a seventh color and/or the icon 300 for the four-unit may be a eighth color wherein the first color, the second color, the third color, the fourth color, the fifth color, the sixth color, the seventh color and/or the eighth color are each a different color.

As further example, the icon 300 for the vacant land may be a first shape, the icon 300 for the single family home may be a second shape, the icon 300 for the townhome may be a third shape, the icon 300 for the condominium may be a fourth shape, the icon 300 for the mobile home may be a fifth shape, the icon 300 for the two-unit may be a sixth shape, the icon 300 for the three-unit may be a seventh shape and/or the icon 300 for the four-unit may be a eighth shape wherein the first shape, the second shape, the third shape, the fourth shape, the fifth shape, the sixth shape, the seventh shape and/or the eighth shape are each a different shape.

The icons 300 on the interactive map 21 may be a different design and/or a different color based on whether the icon 300 represents a property for sale or a property wanted. For example, the icon 300 may be blue if the icon 300 represents one of the properties for sale, and/or the icon 300 may be red if the icon 300 represents one of the properties wanted. The present invention should not be restricted to a specific embodiment of the icon 300.

The server computer 10, the database 11, the system 100 and/or the web application 20 may be designed and/or may be programmed to display the price 202 and/or the price range 402 in any currency. In a preferred embodiment, the server computer 10, the database 11, the system 100 and/or the web application 20 may be designed and/or may be programmed to enable the user 101 to select a type of currency in which the price 202 and/or the price range 402 are displayed. The type of currency in which the price 202 and/or the price range 402 are displayed may be based upon the specific location 201 and/or the general location 401, respectively.

For example, if the specific location 201 of the property for sale is a city in Ireland, the type of currency in which the price 202 is displayed may be Euros. The server computer 10, the database 11, the system 100 and/or the web application 20 may be designed and/or may be programmed to provide a currency menu 26 for the user 101 to adjust the type of currency in which the price 202 and/or the price range 402 may be displayed. The server computer 10, the database 11, the system 100 and/or the web application 20 may be designed and/or may be programmed to have and/or to connect to a real-time currency converter that may provide current currency conversion rates.

The server computer 10, the database 11, the system 100 and/or the web application 20 may be designed and/or may be programmed to enable the user 101 to adjust the type of map for the interactive map 21. For example, the type of map may be a road map that may display roads, a terrain map that may display topography, a hybrid map that may display both the roads and the topography and/or the like. The server computer 10, the database 11, the system 100 and/or the web application 20 may be designed and/or may be programmed to provide a “road map” button 310, a “terrain map” button 311 and/or a “hybrid map” button 312 on the web application 20. The “road map” button 310, the “terrain map” button 311 and/or the “hybrid map” button 312 may allow the user 101 to select to adjust the type of map for the interactive map 21. Further, the server computer 10, the database 11, the system 100 and/or the web application 20 may be designed and/or may be programmed to enable the user 101 to change a map provider for the interactive map 21. For example, the map provider may be Google Maps (trademark of Google Inc.), OpenStreetMap (trademark of The OpenStreetMap Foundation), Live Earth (registered trademark of Microsoft Corporation) and/or the like. The server computer 10, the database 11, the system 100 and/or the web application 20 may be designed and/or may be programmed to provide a map provider menu 320 on the web application 20. The user 101 may use the map provider menu 320 to change the map provider for the interactive map 21.

As discussed previously, the icons 300 may represent properties for sale and/or properties wanted. The server computer 10, the database 11, the system 100 and/or the web application 20 may be designed and/or may be programmed to enable the user 101 to adjust which of the icons 300 are displayed by the interactive map 21. For example, the user 101 may have the interactive map 21 show only icons 300 that represent the properties for sale. The server computer 10, the database 11, the system 100 and/or the web application 20 may be designed and/or may be programmed to provide a “hide buy” button 330 on the web application 20. The user 101 may select the “hide buy” button 330 on the web application 20 to prompt the interactive map 21 to show only the properties for sale. Thus, the server computer 10, the database 11, the system 100 and/or the web application 20 may be designed and/or may be programmed to display only the icons 300 which represent the properties for sale if the user 101 selects the “hide buy” button 330. Since the icons 300 may represent properties for sale and/or properties wanted, the server computer 10, the database 11, the system 100 and/or the web application 20 may be designed and/or may be programmed to not display the icons 300 which represent the properties wanted if the user 101 selects the “hide buy” button 330.

Since the icons 300 may represent properties for sale and/or properties wanted, the user 101 may have the interactive map 21 show only the icons 300 that represent the properties wanted. The server computer 10, the database 11, the system 100 and/or the web application 20 may be designed and/or may be programmed to provide a “hide sell” button 340 on the web application 20. The user may select the “hide sell” button 340 on the web application 20 to prompt the interactive map 21 to show only the properties wanted. Thus, the server computer 10, the database 11, the system 100 and/or the web application 20 may be designed and/or may be programmed to display only the icons 300 which represent the properties wanted if the user 101 selects the “hide sell” button 340. Since the icons 300 may represent properties for sale and/or properties wanted, the server computer 10, the database 11, the system 100 and/or the web application 20 may be designed and/or may be programmed to not display the icons 300 which represent the properties for sale if the user 101 selects the “hide sell” button 340.

The server computer 10, the database 11, the system 100 and/or the web application 20 may be designed and/or may be programmed to provide a search refinement tool 350 that may enable the user 101 to adjust the icons 300 that are displayed by the interactive map 21. The search refinement tool 350 may have buttons that enable the user 101 to direct the interactive map 21 to show only a specific type of property.

For example, the server computer 10, the database 11, the system 100 and/or the web application 20 may be designed and/or may be programmed to provide property type buttons. For example, the property type buttons may be a “vacant land” button 360, a “single family home” button 361, a “townhome” button 362, a “condo” button 363, a “mobile home” button 364, a “two-unit” button 365, a “three-unit” button 366, a “four-unit” button 367 and/or the like. The server computer 10, the database 11, the system 100 and/or the web application 20 may be designed and/or may be programmed to have the interactive map 21 only display icons 300 that represent the vacant lands if the “vacant land” button 360 is selected by the user 101.

The server computer 10, the database 11, the system 100 and/or the web application 20 may be designed and/or may be programmed to have the interactive map 21 only display icons 300 that represent the single family homes if the “single family home” button 361 is selected by the user 101. The server computer 10, the database 11, the system 100 and/or the web application 20 may be designed and/or may be programmed to have the interactive map 21 only display icons 300 that represent the townhomes if the “townhome” button 362 is selected by the user 101. The server computer 10, the database 11, the system 100 and/or the web application 20 may be designed and/or may be programmed to have the interactive map 21 only display icons 300 that represent the condominiums if the “condo” button 363 is selected by the user 101. The server computer 10, the database 11, the system 100 and/or the web application 20 may be designed and/or may be programmed to have the interactive map 21 only display icons 300 that represent the mobile homes if the “mobile home” button 364 is selected by the user 101.

The server computer 10, the database 11, the system 100 and/or the web application 20 may be designed and/or may be programmed to have the interactive map 21 only display icons 300 that represent the two-units if the “two-unit” button 365 is selected by the user 101. The server computer 10, the database 11, the system 100 and/or the web application 20 may be designed and/or may be programmed to have the interactive map 21 only display icons 300 that represent the three-units if the “three-unit” button 366 is selected by the user 101. The server computer 10, the database 11, the system 100 and/or the web application 20 may be designed and/or may be programmed to have the interactive map 21 only display icons 300 that represent the four-units if the “four-unit” button 367 is selected by the user 101.

Moreover, any combination of the property type buttons may be utilized to control the icons 300 displayed on the interactive map 21. For example, both the “three-unit” button 366 and the “four-unit” button 367 may be selected by the user 101. As a result, the interactive map 21 may display both the icons 300 that represent the three-units and the icons 300 that represent the four-units and not display the icons 300 that represent other property types. The combination of the property type buttons may be any combination of the property type buttons known to one skilled in the art.

Further, the user 101 may direct the interactive map 21 to only display icons 300 that represent properties within a user-selected price range. The search refinement tool 350 may have a minimum price input box 370 and/or a maximum price input box 371 on the web application 20. The server computer 10, the database 11, the system 100 and/or the web application 20 may be designed and/or may be programmed to display and/or apply values in the minimum price input box 370 and/or the maximum price input box 371. For example, the user 101 may use the minimum price input box 370 and/or the maximum price input box 371 to direct the interactive map 21 to only display icons 300 that represent the properties for sale having a price 202 within the user-selected price range and/or the properties wanted having a price range 402 within the user-selected price range. The interactive map 21 may not show icons 300 that represent the properties for sale having a price 202 outside of the user-selected price range and/or the properties wanted having a price range 402 outside of the user-selected price range.

Still further, the user 101 may direct the interactive map 21 to only display icons 300 that represent the properties for sale having a number of bedrooms 204 that meets or exceeds a user-selected minimum number of bedrooms and/or the properties wanted having a number of bedrooms 404 that meets or exceeds the user-selected minimum number of bedrooms. The search refinement tool 350 may have a minimum bedrooms input box 380 and/or a maximum bedrooms input box 381 on the web application 20. The server computer 10, the database 11, the system 100 and/or the web application 20 may be designed and/or may be programmed to display and/or to apply values within the minimum bedrooms input box 380 and/or the maximum bedrooms input box 381.

For example, the user 101 may use the minimum bedrooms input box 380 to direct the interactive map 21 to only display icons 300 that represent the properties for sale having a number of bedrooms 204 that meets or exceeds the user-selected minimum number of bedrooms and/or the properties wanted having a number of bedrooms 404 that meets or exceeds the user-selected minimum number of bedrooms. The interactive map 21 may not show icons 300 that represent properties for sale having a number of bedrooms 204 that does not meet or exceed the user-selected minimum number of bedrooms and/or the properties wanted having a number of bedrooms 404 that do not meet or exceed the user-selected minimum number of bedrooms.

For example, the user 101 may use the maximum bedrooms input box 381 to direct the interactive map 21 to only display icons 300 that represent the properties for sale having a number of bedrooms 204 that is less than or equal to the user-selected maximum number of bedrooms and/or the properties wanted having a number of bedrooms 404 that is less than or equal to the user-selected maximum number of bedrooms. The interactive map 21 may not show icons 300 that represent properties for sale having a number of bedrooms 204 that is not less than or equal to the user-selected maximum number of bedrooms and/or the properties wanted having a number of bedrooms 404 that is not less than or equal to the user-selected maximum number of bedrooms.

The user 101 may utilize the minimum bedrooms input box 380 and the maximum bedrooms input box 381 in combination to direct the interactive map 21 to only display icons 300 that represent the properties for sale having a number of bedrooms 204 that meets or exceeds the user-selected minimum number of bedrooms and is less than or equal to the user-selected maximum number of bedrooms. The user 101 may utilize the minimum bedrooms input box 380 and the maximum bedrooms input box 381 in combination to direct the interactive map 21 to only display icons 300 that represent the properties wanted having a number of bedrooms 404 that meets or exceeds the user-selected minimum number of bedrooms and is less than or equal to the user-selected maximum number of bedrooms.

Still further, the user 101 may direct the interactive map 21 to only display icons 300 that represent the properties for sale having a number of bathrooms 205 that meets or exceeds a user-selected minimum number of bathrooms and/or the properties wanted having a number of bathrooms 405 that meets or exceeds the user-selected minimum number of bathrooms. The search refinement tool 350 may have a minimum bathrooms input box 382 and/or a maximum bathrooms input box 383 on the web application 20. The server computer 10, the database 11, the system 100 and/or the web application 20 may be designed and/or may be programmed to display and/or to apply values within the minimum bathrooms input box 382 and/or the maximum bathrooms input box 383.

For example, the user 101 may use the minimum bathrooms input box 382 to prompt the interactive map 21 to only display icons 300 that represent the properties for sale having a number of bathrooms 205 that meets or exceeds the user-selected minimum number of bathrooms and/or the properties wanted having a number of bathrooms 405 that meets or exceeds the user-selected minimum number of bathrooms. The interactive map 21 may not show icons 300 that represent properties for sale having a number of bathrooms 205 that does not meet or exceed the user-selected minimum number of bathrooms and/or the properties wanted having a number of bathrooms 405 that do not meet or exceed the user-selected minimum number of bathrooms.

For example, the user 101 may use the maximum bathrooms input box 383 to direct the interactive map 21 to only display icons 300 that represent the properties for sale having a number of bathrooms 205 that is less than or equal to the user-selected maximum number of bathrooms and/or the properties wanted having a number of bathrooms 405 that is less than or equal to the user-selected maximum number of bathrooms. The interactive map 21 may not show icons 300 that represent properties for sale having a number of bathrooms 205 that is not less than or equal to the user-selected maximum number of bedrooms and/or the properties wanted having a number of bathrooms 405 that is not less than or equal to the user-selected maximum number of bathrooms.

The user 101 may utilize the minimum bathrooms input box 382 and the maximum bathrooms input box 383 in combination to direct the interactive map 21 to only display icons 300 that represent the properties for sale having a number of bathrooms 205 that meets or exceeds the user-selected minimum number of bathrooms and is less than or equal to the user-selected maximum number of bathrooms. The user 101 may utilize the minimum bathrooms input box 382 and the maximum bathrooms input box 383 in combination to direct the interactive map 21 to only display icons 300 that represent the properties wanted having a number of bathrooms 405 that meets or exceeds the user-selected minimum number of bathrooms and is less than or equal to the user-selected maximum number of bathrooms.

Moreover, a combination of previously described tools may be used to adjust the icons 300 displayed by the interactive map 21. Any combination of the property type buttons, the “hide buy” button 330, the “hide sell” button 340, the minimum price input box 370, the maximum price input box 371, the minimum bedrooms input box 380, the maximum bedrooms input box 381, the minimum bathrooms input box 382 and/or the maximum bathrooms input box 383 may be implemented by the user 101 to control the icons 300 displayed by the interactive map 21. The combination of the previously described tools may be any combination of the previously described tools known to one skilled in the art.

For example, the user 101 may select the “hide buy” button 330 and the “townhome” button 362 and may use the minimum price input box 370, the maximum price input box 371, the minimum bedrooms input box 380, the maximum bedrooms input box 381, the minimum bathrooms input box 382 and the maximum bathrooms input box 383. As a result, the interactive map 21 may only display the icons 300 which represent the properties for sale that are townhomes having the user-selected price range, a number of bedrooms 204 that meets or exceeds the user-selected minimum number of bedrooms and is less than or equal to the user-selected maximum number of bedrooms and a number of bathrooms 205 that meets or exceeds the user-selected minimum number of bathrooms and is less than or equal to the user-selected maximum number of bathrooms 205.

The server computer 10, the database 11, the system 100 and/or the web application 20 may be designed and/or may be programmed to display a supply-and-demand chart 390 on the web application 20. In a preferred embodiment, the supply-and-demand chart 390 may be a bar chart that may indicate how many of the properties for sale are located in the geographic area displayed by the interactive map 21. In a preferred embodiment, the supply-and-demand chart 390 may be a bar chart that may indicate how many of the properties wanted are located in the geographic area displayed by the interactive map 21.

The supply-and-demand chart 390 may be any graphic representation that may indicate how many of the properties for sale and/or how many of the properties wanted are located in the geographic area displayed by the interactive map 21. For example, the supply-and-demand chart 390 may be a bar graph, a table of numbers and/or the like. The supply-and-demand chart 390 should not be limited to a specific embodiment of the supply-and-demand chart 390.

The supply-and-demand chart 390 may indicate real-time supply-and-demand data. The real-time supply-and-demand data may be, for example, the current supply-and-demand data that may account for properties for sale recently removed from the system 100 and/or properties wanted recently removed from the system 100.

The server computer 10, the database 11, the system 100 and/or the web application 20 may be designed and/or may be programmed to indicate the supply-and-demand data for only a specific type of property and/or a combination of property types. For example, if the user 101 selects the “vacant land” button 360, the supply-and-demand chart 390 may indicate the supply-and-demand data for only the vacant lands. If the user 101 selects the “townhome” button 362, the supply-and-demand chart 390 may indicate the supply-and-demand data for only the townhomes. If the user 101 selects the “condominium” button 363, the supply-and-demand chart 390 may indicate the supply-and-demand data for only the condominiums. If the user 101 selects the “mobile home” button 364, the supply-and-demand chart 390 may indicate the supply-and-demand data for only the mobile homes. If the user 101 selects the “two-unit” button 365, the supply-and-demand chart 390 may indicate the supply-and-demand data for only the two-units. If the user 101 selects the “three-unit” button 366, the supply-and-demand chart 390 may indicate the supply-and-demand data for only the three-units. If the user 101 selects the “four-unit” button 367, the supply-and-demand chart 390 may indicate the supply-and-demand data for only the four-units.

As further examples, if the user 101 provides the user-selected price range, the supply-and-demand chart 390 may only indicate supply-and-demand data for properties for sale that have a price 202 within the user-selected price range and/or the properties wanted that have a price range 402 that overlaps the user-selected price range. If the user 101 provides the minimum number of bathrooms, the supply-and-demand chart 390 may only indicate supply-and-demand data for the properties for sale that have a number of bathrooms 205 that meets or exceeds the minimum number of bathrooms and/or the properties wanted that have a number of bathrooms 405 that meets or exceeds the minimum number of bathrooms. If the user 101 provides the minimum number of bedrooms, the supply-and-demand chart 390 may only indicate supply-and-demand data for the properties for sale that have a number of bedrooms 204 that meets or exceeds the minimum number of bedrooms and/or the properties wanted that have a number of bedrooms 404 that meets or exceeds the minimum number of bedrooms.

The server computer 10, the database 11, the system 100 and/or the web application 20 may be designed and/or may be programmed to display a list of the properties for sale by the user 101 and/or the properties wanted by the user 101. For example, the web application 20 may provide a “my account” button 391 that may be selected by the user 101. If the user 101 selects the “my account” button 360, the web application 20 may display the list of the properties for sale by the user 101 and/or the properties wanted by the user 101. The web application 20 may require the user 101 obtaining the list of the properties for sale by the user 101 and/or the properties wanted by the user 101 to input the username and/or the password. If the user 101 selects the “my account” button 391, the web application 20 may display input areas for the username and/or the password.

The server computer 10, the database 11, the system 100 and/or the web application 20 may be designed and/or may be programmed to enable the user 101 to select the icon 300 to view detailed information regarding the property for sale that may be represented by the icon 300. For example, the user 101 may select the icon 300 to direct the web application 20 to display the specific location 201, the price 202, the property type 203, the number of bedrooms 204, the number of bathrooms 205, the desired time period for sale 206, the approximate square footage 207, the seller type 208, the property exterior 209, the property condition 210, the air conditioning information 211, the heating information 212, the parking information 213, the rental information 214 and/or the like.

The server computer 10, the database 11, the system 100 and/or the web application 20 may be designed and/or may be programmed to enable the user 101 to select the icon 300 to view detailed information regarding the property wanted that may be represented by the icon 300. For example, the user 101 may select the icon 300 to direct the web application 20 to display the general location 401, the precise geographic area 502 in which a property is desired, the price range 402, the property type 403, the minimum number of bedrooms 404, the minimum number of bathrooms 405, the desired time period for purchase 406, the minimum square footage 407, the buyer type 408, the property exterior 409, the property condition 410, the air conditioning information 411, the heating information 412, the parking information 413, the financing status 414 and/or the like.

After viewing the property information 200 of one of the properties for sale, the user 101 may contact the owner of the property for sale through the web application 20 and/or the system 100. The server computer 10, the database 11, the system 100 and/or the web application 20 may be designed and/or may be programmed to contact the owner of the property for sale via the network 2. The user 101 may contact the owner of the property for sale without providing the system 100 with an area in which the property wanted is located.

For example, the server computer 10, the database 11, the system 100 and/or the web application 20 may be designed and/or may be programmed to provide an electronic form for the user 101 to contact the owner of the property for sale. The electronic form for contacting the owner may be a section of the web application 20 that may have input boxes in which information may be typed. The information transmitted by the buyer may be, for example, a general indication of interest, a bid amount, a desired time frame for purchase, financing status and/or the like. The web application 20 and/or the system 100 may send the owner of the property for sale an email on behalf of the user 101. The server computer 10, the database 11, the system 100 and/or the web application 20 may be designed and/or may be programmed to send the email with an anonymous email address that may allow the user 101 and/or the owner of the property for sale to remain anonymous. The email may convey the information to the owner.

The server computer 10, the database 11, the system 100 and/or the web application 20 may be designed and/or may be programmed to provide an auction feature that may enable the user 101 to input a bid into the system 100 and/or the web application 20. The system 100 may store the bid in the database 11. The owner of the property for sale may establish an auction deadline. The server computer 10, the database 11, the system 100 and/or the web application 20 may be designed and/or may be programmed to cease to accept bids at the auction deadline. The server computer 10, the database 11, the system 100 and/or the web application 20 may be designed and/or may be programmed to determine a highest-bidding user at the auction deadline. The server computer 10, the database 11, the system 100 and/or the web application 20 may be designed and/or may be programmed to inform the highest-bidding user that the bid was the highest and/or the property for sale was purchased. The system 100 and/or the web application 20 may enable the owner of the property for sale to monitor the bids that have been made for the property for sale. The server computer 10, the database 11, the system 100 and/or the web application 20 may be designed and/or may be programmed to inform the owner of the property for sale that the property for sale was purchased. The server computer 10, the database 11, the system 100 and/or the web application 20 may be designed and/or may be programmed to use the registration information, such as, for example, a credit card number, a bank account number and/or the like, to ensure that the highest-bidding user completes a purchase of the property for sale. The registration information may be required to obtain the username and/or the password.

After viewing the property parameters 400 of one of the properties wanted, the user 101 may contact a possible purchaser through the web application 20 and/or the system 100. The server computer 10, the database 11, the system 100 and/or the web application 20 may be designed and/or may be programmed to contact the possible purchaser via the network 2. The user 101 may contact the possible purchaser without listing a property for sale on the system 100.

For example, the server computer 10, the database 11, the system 100 and/or the web application 20 may be designed and/or may be programmed to provide an electronic form for the user 101 to contact the possible purchaser. The web application 20 and/or the system 100 may send the possible purchaser an email on behalf of the user 101. The email may allow the user 101 and/or the possible purchaser to remain anonymous. The electronic form for contacting the possible purchaser may be a section of the web application 20 that may have input boxes in which sale information may be typed. The sale information may be, for example, a general indication of interest, a sale price, a desired time frame for sale, a condition of the property and/or the like. The web application 20 and/or the system 100 may send the possible purchaser an email on behalf of the user 101. The server computer 10, the database 11, the system 100 and/or the web application 20 may be designed and/or may be programmed to the email with an anonymous email address that may allow the user 101 and/or the possible purchaser to remain anonymous. The email may convey the sale information to the possible purchaser.

If the user 101 visits the property for sale, the user 101 may provide feedback information to the system 100. The server computer 10, the database 11, the system 100 and/or the web application 20 may be designed and/or may be programmed to accept and/or to accumulate the feedback information. The feedback information may be, for example, a verification of the property information 200, a ranking of the property for sale, comments regarding the property for sale and/or the like. The feedback information may be displayed to the user 101 by the web application 20 when the user 101 selects the property for sale. The server computer 10, the database 11, the system 100 and/or the web application 20 may be designed and/or may be programmed to display the feedback information on the web application 20. The present invention should not be limited to a specific embodiment of the feedback information.

The server computer 10, the database 11, the system 100 and/or the web application 20 may be designed and/or may be programmed to generate a ranking for one or more of the properties wanted. The ranking may be displayed on the web application 20 if one of the properties wanted is selected. For example, the system 100 may generate a positive ranking based on the price range 402 being narrow, the precise geographic area 502 being small, the financing status 414 being pre-approved and/or the like. As further example, the system 100 may generate a negative ranking based on the price range 402 being wide, the precise geographic area 502 being large, the financing status 414 being “not yet” and/or the like. The present invention should not be limited to a specific embodiment of the ranking.

The server computer 10, the database 11, the system 100 and/or the web application 20 may be designed and/or may be programmed to remove the appropriate icon 300 from the interactive map 21 if one of the properties for sale is purchased, one of the properties for sale is deleted, the user 101 no longer desires the property wanted, and/or the user purchases a property corresponding to the property wanted. Thus, the server computer 10, the database 11, the system 100 and/or the web application 20 may be designed and/or may be programmed to display real-time information regarding the properties for sale and/or the properties wanted. The real-time information regarding the properties for sale and/or the properties wanted may be, for example, the current information regarding the properties for sale and/or the properties wanted that may account for properties for sale recently removed from the system 100 and/or properties wanted recently removed from the system 100.

FIG. 5 generally illustrates a flowchart of a method 600 for displaying real estate properties for sale, real estate properties wanted and areas in which properties are for sale and/or desired. The user may view an interactive map displaying properties for sale and/or properties wanted, as generally shown at step 601. The user may search the interactive map for properties for sale and/or properties wanted that meet user-specified parameters, as generally shown at step 602. The user may select a property for sale or a property wanted to view the characteristics of the selected property for sale or the property wanted, respectively, as generally shown at step 603. The user may use the system to send an email to an owner of the selected property for sale or a purchaser for the property wanted, respectively, as generally shown at step 604.

The user may input the property information for a property for sale, as generally shown at step 605. The system may place an icon representing the property for sale on the interactive map, as generally shown at step 606. The user may correct placement of the icon representing a property for sale on the interactive map, as generally shown at step 607. The system may move the icon representing a property for sale to a corrected position on the interactive map, as generally shown at step 608. The user may then return to the interactive map, as generally shown at step 609.

The user may input the property parameters for a property wanted, as generally shown at step 610. The user may select points that define a precise geographic area in which the property wanted is located, as generally shown at step 611. The system may place an icon representing the area in which the property wanted is located on the interactive map, as generally shown at step 612. The user may then return to the interactive map, as generally shown at step 613.

The system, the method, the web application and the interactive map may be encoded using any coding technology known to one skilled in the art. For example, Flex open source framework, MXML user interface markup language, ActionScript 3 scripting language, PHP 4 scripting language, PHP 5 scripting language, MySQL database management system and/or Action Message Format for PHP (AMFPHP) may be employed. In a preferred embodiment, data from the MySQL database management system may be transmitted to a Flash Client for display. The present invention should not be limited to a specific embodiment of the coding technology.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A method for displaying real estate properties for sale and real estate properties wanted, the method comprising the steps of:
providing a web application via a network wherein the network is connected to a database that stores information regarding the real estate properties for sale and information regarding the real estate properties wanted and further wherein the web application communicates with the database via the network;
displaying a map on the web application;
displaying a first set of icons on the map wherein the first set of icons is associated with the real estate properties for sale;
displaying a second set of icons on the interactive map wherein the second set of icons is associated with the real estate properties wanted;
inputting a parameter;
comparing the parameter to the information for the real estate properties for sale and the information for the real estate properties wanted; and
indicating which icons of the first set of icons are associated with the real estate properties for sale that have information that matches the parameter and which icons of the second set of icons are associated with the real estate properties wanted that have information that matches the parameter.

2. The method of claim 1 wherein the first set of icons is different than the second set of icons.

3. The method of claim 1 further comprising the step of:
displaying a new icon on the interactive map wherein the new icon is associated with a new real estate property for sale.

4. The method of claim 1 further comprising the step of:
displaying a new icon on the map wherein the new icon is associated with a new real estate property wanted.

5. The method of claim 1 further comprising the step of:
removing one of the first set of icons after one of the real estate properties for sale is no longer listed.

6. The method of claim 1 further comprising the step of:
converting prices for the real estate properties for sale and the real estate properties wanted from a first type of currency to a second type of currency wherein the first type of currency is different than the second type of currency.

7. The method of claim 1 further comprising the step of:
removing one of the second set of icons after one of the real estate properties wanted is no longer listed.

8. The method of claim 1 further comprising the step of:
displaying the information if a user selects one of the icons.

9. The method of claim 1 further comprising the step of:
displaying the web application on a plurality of computers wherein the plurality of computers are connected to the network and further wherein the network is the internet.

10. The method of claim 1 further comprising the step of:
adjusting a location of one of the first set of icons wherein adjustment of the location is based on user input.

11. The method of claim 1 further comprising the step of:
compiling feedback information for the real estate properties for sale wherein the web application compiles the feedback information and further wherein the feedback information is input from users that have contacted owners of the real estate properties for sale.

12. The method of claim 1 further comprising the step of:
changing the information regarding the real estate properties for sale and the information regarding the real estate properties wanted wherein the database stores changes in the information regarding the real estate properties for sale and the information regarding the real estate properties wanted.

13. The method of claim 1 further comprising the step of:
adjusting the map to show any location in the world.

14. A system for displaying real estate data, the system comprising:
a database connected to a network wherein the database stores information associated with real estate properties for sale and real estate properties wanted;
a web application associated with the database wherein a user views the web application on a computer connected to the network and further wherein the web application accepts user input;
a map displayed on the web application wherein the map displays icons that represent the real estate properties for sale and the real estate properties wanted that match the user input; and
a graphic representation displayed on the web application wherein the graphic representation indicates how many of the real estate properties for sale have information that matches the user input and how many of the real estate properties wanted have information that matches the user input.

15. The system of claim 14 further comprising:
a server that stores the database wherein the server is located at a location remote from the computer connected to the network.

16. A method for displaying real estate information, the method comprising the steps of:
providing a web application via a computer network;
displaying a map on the web application;
inputting three or more geographic points that define a perimeter of an area in which a property wanted is located wherein the three or more geographic points are input via the web application by a first user; and
displaying a first icon on the map wherein the first icon on the map is associated with the property wanted and the area in which the property wanted is located.

17. The method of claim 16 further comprising the step of:
displaying information regarding the area in which the property wanted is located wherein the information is displayed to a second user if the second user selects the first icon.

18. The method of claim 16 further comprising the step of:
displaying a second icon on the map wherein the second icon is associated with a real estate property for sale and further wherein the first icon is different than the second icon.

19. The method of claim 16 further comprising the step of:
adjusting the map to show any location in the world.

20. The method of claim 16 further comprising the step of:
displaying a ranking for the property wanted wherein the ranking is based on information related to the property wanted.
